(19) United States
(12) Patent Application Publication
(10) Pub. No.: US 2024/0408537 A1
(43) Pub. Date: Dec. 12, 2024

(54) RAPID CAPTURE AND CONVERSION OF CO2 TO FUELS USING NANOFLUID SUSPENSION ELECTRODES

(71) Applicant: Sujat Sen, La Crosse, WI (US)

(72) Inventor: Sujat Sen, La Crosse, WI (US)

(21) Appl. No.: 18/739,025

(22) Filed: Jun. 10, 2024

Related U.S. Application Data
(60) Provisional application No. 63/507,318, filed on Jun. 9, 2023.

(51) Int. Cl. B01D 53/14; C25B 3/03; C25B 3/07; C25B 3/26

(52) U.S. Cl. CPC B01D 53/1475; C25B 3/03; C25B 3/07; C25B 3/26; B01D 2257/504; B01D 2259/80

(57) ABSTRACT

According to various aspects, the present invention speaks to a catalytic nanofluid for capturing carbon dioxide which includes a distribution of nanoparticles. The nanoparticles may include Ni, Cu, Sn, Ag, Ti, V, Cr, Zn, Ru, Rh, Pt, Au, Fe, C, oxides thereof, composites thereof, complexes thereof, alloys thereof, or mixtures thereof. The distribution of nanoparticles can range from about 1 wt % to about 95 wt % of the nanofluid. A viscosity of the nanofluid can be in a range of from about 1 cP to about 5000 cP.

### CROSS-REFERENCE TO RELATED APPLICATION

This application claims the benefit of priority to U.S. Provisional Patent Application Ser. No. 63/507,318 entitled “RAPID CAPTURE AND CONVERSION OF CO2 TO FUELS USING NANOFLUID SUSPENSION ELECTRODES,” filed Jun. 9, 2023, the disclosure of which is incorporated herein in its entirety by reference.

### BACKGROUND

The effect of carbon dioxide (CO2) accumulation on climate change has garnered significant concern. Current remediation focus is on developing Carbon Capture and Storage (CCS) technologies. However, CO2 is also abundant and non-toxic, and maturing CCS technology will soon make available increasing amounts of it as feedstock of zero or even negative cost. A Majority of renewable energy (RE) technologies such as solar, wind, thermal and tidal generate electrical energy, which can be coupled with a conversion process producing chemicals that can be easily inserted into the existing chemical production chain.

### SUMMARY OF THE INVENTION

According to various aspects, a catalytic nanofluid for capturing carbon dioxide includes a distribution of nanoparticles. The nanoparticles include Ni, Cu, Sn, Ag, Ti, V, Cr, Zn, Ru, Rh, Pt, Au, Fe, C, oxides thereof, composites thereof, complexes thereof, alloys thereof, or mixtures thereof. The distribution of nanoparticles can range from about 0.1 wt % to about 95 wt % of the nanofluid. A viscosity of the nanofluid can be in a range of from about 1 cP to about 5000 cP.

### BRIEF DESCRIPTION OF THE FIGURES

The drawings illustrate generally, by way of example, but not by way of limitation, various embodiments of the present invention.

FIG. 1 is a schematic diagram demonstrating the use of a nanofluid as a medium for CO₂ capture (from flue gas) followed by conversion to a value added product (CO or HCOOH) in an electrochemical flow reactor. The catalytic conversion occurs at the surface of the nanoparticle at the time of an impact event with the current collector. After exiting the flow reactor, the product can be easily separated from the nanofluid, making it ready for another conversion cycle.

### DETAILED DESCRIPTION OF THE DISCLOSURE

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4,3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

According to various aspects of the present disclosure a catalytic nanofluid can be used to capture carbon dioxide. The captured carbon dioxide, in turn, can be converted into a desired reaction product. Non-limiting examples of desired reaction products can include formic acid, formate, carbon monoxide, methanol, glyoxal, methane, acetate, acetic acid, glycoaldehyde, ethylene glycol, acetaldehyde, ethanol, ethylene, hydroxyacetone, acetone, allyl alcohol, propionaldehyde, 1-propanol, or a mixture thereof.

The catalytic nanofluid includes a distribution of nanoparticles. The nanoparticles include Ni, Cu, Sn, Ag, Ti, V, Cr, Zn, Ru, Rh, Pt, Au, Fe, C, oxides thereof, composites thereof, complexes thereof, alloys thereof, or mixtures thereof. More broadly, nanoparticles may be selected from a variety of redox materials. In some embodiments, the nanoparticles include, a metal, an intermetallic, a metal oxide, a mixed metal oxide, a metal phosphate, a metal alloy or a carbonaceous material. Examples of suitable redox materials include but are not limited to metals, e.g., intercalating elements (A) such as Li, Na, Mg, Sn, Ca, Zn, Al, Si, Ge, and B, or transition metals (M, M₁, M₂) such as Y, Zr, Mn, Fe, Co, Ni, Cu, Zn, Ag, In, Sn, Sb, Bi, La, Ce,

Mg, Sr, Ba, Ca, Ti, V, Al, Si, Hf, Nb, Ta, Cr, V, W and Mo, A_{y}MOₓ compounds, A_{y}M₁M₂Oₓ compounds, metal phosphates and mixed metal phosphates A_{y}MPO₄ and A_{y}M₁M₂PO₄, wherein M, M₁, and M₂ have an oxidation state of +1, +2, +3, +4, +5, +6, or +7 and x and y refer to mole % such that y is from 0 to 2 and x is from 2 to 4, including fully or partially fluorinated derivatives thereof, alloys thereof, and combinations of any two or more thereof. In some embodiments, the nanoparticles include an intermetallic or intermetallic alloy such as, but not limited to, Cu₆Sn₅, Co₂Sn, Ni₃Sn₄, InSn, FeAl, Fe₃Al, NiAl, FeCoV, and mixtures of any two or more thereof a metal oxide such as, but not limited to FeOx, MgO, NiOx, SrOx, ZnOx, TiO₂, CeO₂, VₓO_{y}, ZrOₓ, SnOₓ, SiOₓ, AgₓO, WₓO_{y}, FeₓO_{y}, MnₓO_{y}, CoₓO_{y}, CrₓO_{y}, MoxOy, and mixtures of any two or more thereof. In some embodiments, the nanoparticles include a carbonaceous material such as, but not limited to, fullerenes, fullerites, graphite, graphene, multilayered graphene sheets, graphene nanoribbons, carbon nanotubes, activated carbon, carbon composites with transitional metal oxides, Si, Sn, Bi, Ge, intermetallic alloys such as Cu₆Sn₅, and combinations of any two or more thereof. The solid electroactive nanoparticles provide for increased volume concentrations of the electroactive material in the liquid redox material, thereby dramatically increasing the energy density compared to traditional salt-based (solubility limited) redox electrolytes. In some instances, use of dispersed nanoparticles allows use of electroactive compounds with low solubility.

In general, the distribution of nanoparticles ranges from about 1 wt % to about 95wt % of the nanofluid, about 20 wt % to about 40 wt % of the nanofluid, less than, equal to, or greater than about 1 wt %, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or about 95 wt %.

As non-limiting examples, a largest dimension (e.g., length or diameter) of an individual nanoparticle is in a range of from about 85 nm to about 500 nm, about 100 nm to about 150 nm, less than, equal to, or greater than about 85 nm, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 nm.

A viscosity of the nanofluid can be a range of from about 1 cP to about 5000 cP, measured at 25° C. using a Brookfield DV-II+rotational type viscometer with the SC4-18 spindle about 2 cP to about 10 cP, less than, equal to, or greater than about 1 cP, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 50, 100, 200, 300, 400, 500, 600, 700, 800, 900, 1000, 1500, 2000, 2500, 3000, 3500, 4000, 4500, or about 5000 cP. A viscosity within this range generally ensures that the nanofluid is able to flow within a device. Higher viscosity may result in the fluid not being able to flow properly.

As generally understood, A nanofluid is a fluid containing nanometer-sized particles (e.g., at least one dimension (x,y, or z) of the nanoparticle has a value of less than 1 micrometer), called nanoparticles. These fluids are engineered colloidal suspensions of nanoparticles in a base fluid. The nanoparticles used in nanofluids are typically made of metals, oxides, carbides, or carbon nanotubes. Suitable base fluids include water, ethylene glycol and oil.

At least some of the individual nanoparticles of the nanofluid can include an organic graft functionalized thereto. As an example, the organic graft can include a silane-based organic material, an amine, a carboxylic acid, a sulfonate, a phosphonate, or a mixture thereof. Examples of silane-based organic material include 3-(trihydroxysilyl)-1-propane sulfonic acid. The graft can be any substance or mixture of substances that can interact with carbon dioxide, the graft is intended to capture carbon dioxide. That is it can be a substance or mixture of substances that can bind to carbon dioxide or react with carbon dioxide to form a reaction product or intermediate product. The amount of organic graft present on an individual nanoparticle can vary, for example, on an individual basis the organic graft can range from about 2 wt % to about 50 wt % of a nanoparticle, about 3 wt % to about 7 wt %, less than, equal to, or greater than about 2 wt %, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, or about 50 wt %. In some examples, each nanoparticle can have the same amount of organic graft or a different amount of organic graft. In some examples, each nanoparticle can have the same organic graft. In some further examples, at least two nanoparticles can have different organic grafts (e.g., one nanoparticle may have a silane-based organic material and another nanoparticle can have an amine).

The size, material, and grafting of the individual nanoparticles can help to ensure that the nanofluid is substantially free of agglomerations. An advantage of the nanoparticles being free of agglomerations is that more surface area of the individual nanoparticles is available to contact carbon dioxide and the more easily the overall nanofluid can flow.

The nanofluid can be disposed within a device. As a non-limiting example, a device can include an inlet for introducing carbon dioxide to the device. The nanofluid can be disposed within a chamber, channel, or the like within the device. The inlet is in fluid communication with the nanofluid. The rate at which the carbon dioxide stream is contacted with the nanofluid can be controlled to ensure maximum efficiency.

After the nanofluid and carbon dioxide are contacted, the carbon dioxide can be functionalized to the nanoparticles of the nanofluid. The functionalized nanoparticles can be stored for a period of time thus providing a method of storing carbon. The functionalized nanoparticles can also be sent to a reaction zone. The reaction zone can include an electrode that converts carbon dioxide into a reaction product through electrolysis. Reaction product can be separated through centrifugation, column chromatography, or any other suitable method. Reaction product can be removed from the device through a reaction product outlet. A pump can be incorporated into the device to move the nanofluid through the device.

As non-limiting examples, the reaction product can be expected to be produced at a rate of about 3 kg/day to about 2000 kg/day, about 1000 kg/day to about 2000 kg/day, less than, equal to, or greater than about 3 kg/day, 10, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 kg/day. Overall, about 50 wt % to about 99 wt % of the total amount of carbon dioxide supplied can be converted to reaction product, about 80 wt % to about 95 wt %, less than, equal to, or greater than about 50 wt %, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99 wt %.

### EXAMPLES

Various embodiments of the present invention can be better understood by reference to the following Examples which are offered by way of illustration. The present invention is not limited to the Examples given herein.

Effects of carbon dioxide (CO₂) accumulation on climate change has garnered significant concern and the current focus is on developing Carbon Capture and Storage (CCS) technologies. However, CO₂ is also abundant and non-toxic, and a maturing CCS technology will soon make available increasing amounts of it as feedstock of zero or even negative cost. The majority of renewable energy (RE) technologies such as solar, wind, thermal and tidal generate electrical energy, which can be coupled with a conversion process producing chemicals that can be easily inserted into the existing chemical production chain. This represents a 3-Step sustainable carbon capture and utilization (CCU) approach viewing CO2 as a resource rather than a waste.
Step1: Renewable Energy (Solar, Wind)→Electricity
Step 2: Use electricity to drive the conversion of CO₂ into base chemicals such as formic acid (HCOOH), or methane (CH₄)
Step 3: Conversion of base chemicals to those of widespread commercial relevance.
   Such a CCU approach has numerous technical and economic benefits over CCS methods. However, conversion technologies in the 2nd step (e.g. chemical, biochemical, photochemical and electrochemical) are currently the bottleneck, being far from being cost competitive with traditional methods of generating the same chemicals. This is largely due to an inversely coupled relationship between efficiency (%) and product generation rates (moles/hour or kg/day).

Within the realm of electrochemical methods significant progress has been made over the past decade, yet most catalysts are evaluated in electrochemical cells that operate at relatively low current densities (1-10 mA/cm²), resulting in low conversion rates (<<10 moles/hour). State of the art electrochemical reactors using solid-state 3D nanostructured electrodes can enhance these conversion rates further to 50-100 mA/cm². Additional Gas-diffusion electrode (GDE) designs have also merged in the past 5 years, and have demonstrated impressive operational current densities of up to 1000 mA/cm² (for CO production) and more modest 500 mA/cm² (for HCOOH production). However, these GDE-based designs currently are subject to limited lifetimes due to flooding events and remains an active area of research. Furthermore, any practical electrochemical reactor is also subject to mass-transfer limitations, which creates an inverse relationship between the current efficiency (CE) and the applied current density (CD) i.e., a larger CD will lower the CE of the process, due to intricately coupled limitations in efficiency and product generation rates. This is partially due to mass transport limitations (set by low diffusivity of the reacting CO₂) but also due to low catalyst specific surface area and access to catalytic sites that together set an upper limit on the conversion rates. This remains a major challenge for further development of CO₂ conversion technologies, and requires a fundamental understanding of mass-transport considerations as well as means to enhance catalyst specific area. To get a holistic perspective on this conversion rate, we can also look at state of the art chemical (not electrochemical) catalytic methods to generate formate from CO2. It is thought that the hydrogenation of CO₂ using an Mn-based homogeneous catalyst at 115° C., 30-60 bar pressure of CO₂ and H₂, generating formate with 70% selectivity at a rate of 230,000 mol/hr. While this conversion rate is orders of magnitude higher than typical electrochemical reactors, the catalyst has limited lifetime and requires sophisticated synthesis equipment, H₂ source and is not linearly scalable unlike typical electrochemical reactors. Catalyst with long lifetimes up to 48 hours have been achieved with similar transition metal catalysts, but with more modest conversion rates of 1000-5000 mol/hr.

Electrochemical methods of CO₂ conversion have high potential for commercial viability, with several advantages: (1) a high process efficiency (>90%) largely due to availability of excellent heterogeneous catalysts; (2) it is a room-temperature process, which does not require a source of heat unlike most chemical catalysis; (3) it can use electricity derived from RE sources ensuring that no new CO₂ is generated, thereby mitigating further emissions and making the carbon cycle sustainable; (4) the electrochemical reactors are compact, modular, on-demand, and easy for scale-up application and deployment to remote areas; (5) the process can be customized to provide a preferred product as the situation requires; (6) with careful engineering and process development, anodic (counter) reactions can be performed using waste water. A variety of useful chemicals and fuels can be obtained by reducing CO₂ electrochemically such as CO, HCOOH, CH₃OH and CH₄. Amongst them, the 2e− reduction products (CO and HCOOH) are energetically most efficient to generate. Both also find use as precursors in the chemical industry. Formic acid (FA) or its salts find use in leather tanning, animal feeds, preservatives, disinfectants, heat transfer fluids, deicing agents and in latex processing. It also has potential as a fuel using direct formic acid fuel cell technology (DFAFC). CO has immense commercial value as a precursor chemical e.g. to generate hydrocarbons using the established Fisher-Tropsch process. One of the principal limitations of using electrochemical reactors, is the rate at which products are generated (moles per hour), which is directly dependent upon the reactor current. Installed capital cost of electrochemical reactors ranges from $10K to $30K per square meter of geometric electrode area. This requires a practically feasible reactor to operate at geometric current densities (CD) above 1000 A/m² (or 100 mA/cm²) in order to achieve a cost competitive rate of product generation. However, any practical electrochemical reactor is also subject to mass-transfer limitations, which creates an inverse relationship between the current efficiency and the applied CD i.e., a larger CD will lower the efficiency of the process. The disclosed approach using nanofluids addresses both these critical issues—(i) the cost of electrode installation, maintenance and (ii) the decrease in efficiency with rising operational currents.

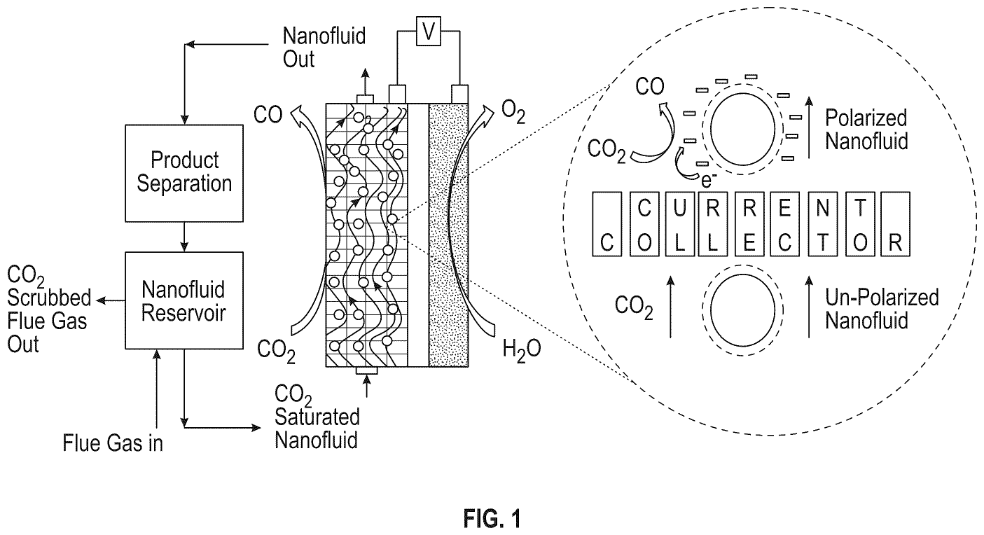

An electrocatalytic reactor is disclosed that utilizes existing electrocatalyst materials as nanofluid (suspension) electrodes instead of current state-of-the-art 3D solid electrodes. The feasibility of nanofluid electrodes (electroactive nanoparticles stably suspended in electrolyte) for electrochemical energy storage (i.e. Batteries), achieving >95% utilization as compared to the solid state equivalent is established. The ability of the nanofluid to charge/discharge in a suspension demonstrates that dispersed nanoparticles in a fluid are electrochemically accessible. Slurry type reactors are common in chemical and photo-catalytic technology, where the catalyst is suspended in the liquid phase with the help of mechanical or gas promoted agitation. This recent work demonstrates that these nanofluid electrodes can be utilized for CO₂ electro-reduction-herein the electrocatalyst is present as nanoparticles stably suspended in a fluid electrolyte and convection is maintained by constant pump-assisted flow as shown in FIG. 1.

This system will have considerable technical advantages over a reactor using the same type of electrocatalyst in the traditional 3D solid-state form: (1) Suspended nanopowders have orders of magnitude higher surface area than their bulk counterparts or even nanostructured 3D bulk electrodes i.e. for the same volume, the high surface area to volume ratio in nanofluid electrodes would amplify the reactor current at a given current density (CD). Enabling high reactor currents at a low CD will in turn significantly amplify product generation rates, while maintaining high process efficiency. Table I describes the use of a nanofluid cathode in a state of the electrochemical reactor estimates a 350X enhancement in product generation rates from 3.79 kg/day (solid electrode) to 1329 kg/day (nanofluid electrode) for the same reactor size. (2) Loading of nanoparticles in nanofluid electrodes can be easily varied from ˜10 wt. % up to 60 wt. %. Using higher solid loadings would enable orders of magnitude larger reactor currents (10 wt. % used for estimates in Table 1) and hence conversion rates (additional 6-fold increase to ˜8 tonnes/day compared to 10 wt % nanofluid); (3) the pump-assisted flow format of the nanofluid catalyst will provide additional convection, enhancing interactions of the gascous and dissolved CO₂ with the catalyst surface as compared to a 3D solid-state electrode, where interactions are heavily dependent on diffusion rates, directional gas flow or mechanical agitation. Furthermore, based on recent rheology studies, these nanofluid suspensions have been demonstrated to have a Newtonian share rate profile which means that pumping power required to flow them will be minimal and fixed. (4) Products can easily be isolated from the catalyst system via outlets for gascous products and via centrifugation/filtration of the nanofluid to isolate the nanoparticles from dissolved liquid products. The catalyst can be subsequently re-dispersed in electrolyte making this a reusable catalyst and technology concept. (5) Prolonged electrolysis (>1 week) has been known to create black deposits on 3D solid-state electrodes, typically some form of graphitic carbon. Hence, these electrodes must be replaced or reprocessed periodically for continued use. This can be circumvented by using graphitic current collectors in combination with the nanofluid catalyst. Furthermore, the replacement and reprocessing of nanofluid suspensions is considerably simpler than that of solid 3D electrodes, which require complex disassembly or replacement procedures. The Design and operational simplicity of the overall reactor will reduce capital costs.

TABLE 1
Quantitative comparison of CO2 conversion rates demonstrating the advantages of using nanofluids inside a conventional trickle
bed electrochemical reactor. Metrics adapted from (a) solid state cathode in lab-scale trickle bed flow reactor and (b)
if a nanofluid cathode was used in the same reactor assuming equivalent current density (1000 A/m2 ) and reactor volume.

| Operational parameter | Solid state cathode [symbol] in trickle-bed reactor | | Nanofluid cathode in same reactor | |
|---|---|---|---|---|
| Specific area of cathode | 14000 m²/m³ | | 5 × 10 [symbol] m [symbol] /m [symbol] assuming 10 wt. % loading [symbol] | |
| | | | specific area of 50 m²/g for 50 [symbol] m particles | |
| Electrode volume | 150 mm × 32 mm × 3 [symbol] 2 mm = | | 1.536 × 10 [symbol] m [symbol] | |
| | 1.536 × 10 [symbol] m [symbol] | | | |
| Total cathode area | 0.215 | m² | 76 | m² |
| Total reactor current at fixed current density (1000 A/m²) | 215 | A | 76 | kA |
| Charge passed in 1 hr [symbol] of electrolysis | 215 Ahr or 774 kC | | 76 kAhr or 273 MC | |
| Total amount of formate generated at 5.18 μmol/C [symbol] (2 [symbol] | 3.44 mol/hr or 3.79 kg/day at 86% CE | | 1216 mol/hr or 1329 kg/day at 86% CE | |
| reduction) | | | | |
| Total electrolyte passed through in 1 hr [symbol] at 20 ml/min | 1.2 | L | 1.2 | L |

| | | |
|---|---|---|
| Concentration of formate solution generated | 2.87M | 1013M |

*Operating conditions[7, 8]
Anolyte: 2M KOH, 60 ml/min.
Catholyte: 0. [symbol] M KHCO [symbol] 2M KCl; 20 ml/min
Gas feed: 1.6-2.2 SL min [symbol] , 100% vol CO₂
Voltage: 2.7-4.3 V
Separator: Na [symbol] on 117
Cathode: 3D solid cathode with tin granules [symbol]
indicates data missing or illegible when filed

A challenge in this proposed assembly is primarily in (a) the electrochemical accessibility of the particles in fluid, and (b) the ability to control the viscosity of such concentrated nanofluid electrodes, which have both been demonstrated by recent experiments. The viscosity of a suspension increases non-linearly with particle concentrations, resulting in pumping power penalties and poor efficiencies. To tackle this challenge, a simple one-step procedure is disclosed that enables high concentration nanofluids with easily manageable viscosities (e.g. <5 cP at 50 wt. % solid loading). The most recent study demonstrated the successful surface modification and electrochemistry on Nickle hydroxide (Ni(OH)₂) nanoparticles, but this approach has been also modified and successfully applied to other nanomaterials (e.g. Sn, CuO, SnO₂) which are known catalysts for CO₂ reduction. This surface modification procedure also ensures spatial separation of the individual particles (confirmed by DLS studies), resulting in minimal aggregation and access to the entirety of the particle's surface area. The resulting nanoparticle suspensions are highly stable against gravity induced settling (>1 month at rest), eliminating the need for any additional means of agitation to maintain suspension stability. Dry nanoparticles (NP) were either purchased (Cu, CuO, Sn, SnO₂, Ag) or synthesized in-house (e.g. Ni(OH)₂) before surface modification with various silane-based organic grafts assisted by a combination of heating, mechanical stirring and ultrasonic tool to ensure monolayer coverage and minimal agglomeration. Preliminary testing with thermogravimetric testing (TGA) confirms the presence of 2-3 wt. % of the organic graft in a typical nanoparticle sample, although this needs further study and optimization at this time.

Dilute suspensions of catalytically active nanoparticles (NP) such as commercially available tin or tin oxide (<100 nm) were prepared. These suspensions were mixed thoroughly and then placed in a horn sonicator and then an ultrasonic bath for an hour cach. Following this nanofluid preparation, the pristine (no surface coating) nanofluids were found to be stable for at least 3 hours, after which minor amounts of sediment were visible. This stability against sedimentation was found to be significantly longer for the surface modified sample, which has minimal sedimentation after 24 hours.

After preparation of the tin/tin oxide catalyst suspension, the full flow cell was assembled, with a high surface area porous current collector on the cathode side, Ag/AgCl reference electrode, and an appropriate counter electrode as anode. The nanofluid suspension was pumped into the cathode liquid chamber, which was physically separated from the anode chamber by a membrane), necessary to prevent the anodic oxidation of the catalyst or any liquid-phase products of CO₂ reduction. Gaseous CO₂ was pumped into the cathode using a mass-flow controller and the outlet gases were sent to a gas chromatograph (not shown).

The electrolysis was conducted at various applied bias (vs. Ag/AgCl) for a duration 1-6 hours using a VSP-300 Bio-Logic potentiostat with a typical electrolysis conducted at a constant potential between −1.3 to −2.1 V vs. Ag/AgCl. After electrolysis, the circulating catalyst-loaded cathode fluid was collected and centrifuged to isolate NP's and the supernatant was subsequently analyzed by water-suppressed 1 H NMR. Based on multiple experiments, repeated at various cathode bias, formate (HCOO—) was readily detected as a known product of CO₂ reduction at tin/tin oxide surfaces. The faradaic or current efficiency (CE) for this conversion process was determined to be in the range of 5-21% and associated current densities (CD) of <10 mA/cm². While this CE and CD is significantly lower than values reported at tin or tin oxide surfaces in the traditional solid-state format or GDE format, it represents proof of this concept of a fluidized nanofluid cathode applied to the conversion of CO₂ into valuable products. As a relevant control experiment, electrolysis conducted under identical conditions without the use of catalyst NPs, yielded a negligible amount (faradaic efficiency calculated to be <0.5%) of formate as a product of CO₂ reduction. This now needs further studies for understanding changes in (a) electrochemical behavior as a function of solid loading (wt. %) of the catalysts in the nanofluid, and (b) optimized reactor design to boost efficiency (CE) as well as production rates (CD) given the theoretical maximum target identified in Table 1. Finally, as shown in FIG. 1, the composition of this nanofluid suspension could be easily modified to include chemical species such as amines or other moieties which would serve as a CO₂ capture/sequestration media through established reversible physio/chemisorption mechanisms. This would enable a dual functionality to the proposed nanofluid suspensions—as being capable of both CO₂ capture (sorption step) and then subsequent conversion to fuels (electrochemical steps). While nanofluids have already been explored for their CO₂ adsorption properties, the dual functionality of the nanofluid would be novel and enable process intensification at industrial scales. However, the addition of amines or other similar chemical moieties will likely affect the electrochemical process and remains a subject for future investigation.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Aspects.

The following exemplary aspects are provided, the numbering of which is not to be construed as designating levels of importance:

Aspect 1 provides a catalytic nanofluid for capturing carbon dioxide, the catalytic nanofluid comprising:
a distribution of nanoparticles, the nanoparticles comprising Ni, Cu, Sn, Ag, Ti, V, Cr, Zn, Ru, Rh, Pt, Au, Fe, C, oxides thereof, composites thereof, complexes thereof, alloys thereof, or mixtures thereof, wherein
the distribution of nanoparticles ranges from about 1 wt % to about 95 wt % of the nanofluid; and
a viscosity of the nanofluid is in a range of from about 1 cP to about 5000 cP.

Aspect 2 provides the catalytic nanofluid of Aspect 1, further comprising an organic graft on at least a portion of the distribution of nanoparticles.

Aspect 3 provides the catalytic nanofluid of Aspect 2, wherien the organic graft comprises a silane-based organic material, an amine, or a mixture thereof.

Aspect 4 provides the catalytic nanofluid of Aspect 3, wherien the silane-based organic material comprises 3-(trihydroxysilyl)-1-propane sulfonic acid.

Aspect 5 provides the catalytic nanofluid of any of Aspects 2-4, wherein on an individual basis the organic graft comprises from about 2 wt % to about 20 wt % of a nanoparticle.

Aspect 6 provides the catalytic nanofluid of any of Aspects 2-5, wherein on an individual basis the organic graft comprises from about 3 wt % to about 7 wt % of a nanoparticle.

Aspect 7 provides the catalytic nanofluid of any of Aspects 1-6, wherien the distribution of nanoparticles ranges from about 20 wt % to about 40 wt % of the nanofluid.

Aspect 8 provides the catalytic nanofluid of any of Aspects 1-7, wherien the viscosity of the nanofluid is in a range of from about 2 cP to about 10 cP.

Aspect 9 provides the catalytic nanofluid of any of Aspects 1-8, wherein the nanofluid is substantially free of agglomerations.

Aspect 10 provides the catalytic nanofluid of any of Aspects 1-9, wherein a largest dimension of an individual nanoparticle is in a range of from about 85 nm to about 500nm.

Aspect 11 provides the catalytic nanofluid of any of Aspects 1-10, wherein a largest dimension of an individual nanoparticle is in a range of from about 100 nm to about 150nm.

Aspect 12 provides a device comprising:
a carbon dioxide inlet;
the catalytic nanofluid of any of Aspects 1-11, in communication with the carbon dioxide inlet;
an electrode; and
a reaction product outlet.

Aspect 13 provides the device of Aspect 12, wherein the device is capable of producing about 3 kg/day to about 2000 kg/day of reaction product.

Aspect 14 provides the device of any of Aspects 12 or 13, wherein the device is capable of producing about 1000 kg/day to about 2000 kg/day of reaction product.

Aspect 15 provides the device of any of Aspects 12-14, further comprising a pump to move the nanofluid.

Aspect 16 provides the device of any of Aspects 12-15, wherein the reaction product comprises formate, methane, or a mixture thereof.

Aspect 17 provides the device of any of Aspects 12-16, wherien the electrode is located at a downstream location that the nanofluid can be selectively contacted with.

Aspect 18 provides a method of capturing carbon dioxide, the method comprising:
contacting carbon dioxide with the nanofluid of any of Aspects 1-17.

Aspect 19 provides a method of converting carbon dioxide into a reaction product, the method comprising:
contacting the nanofluid of Aspect 18 with an electrode; and
applying an electrical current to the electrode.

Aspect 20 provides the method of Aspect 19, wherien about 80 wt % to about 95 wt % of the total amount of carbon dioxide contacted with the nanofluid is converted to the reaction product.

What is claimed is:

1. A catalytic nanofluid for capturing carbon dioxide, the catalytic nanofluid comprising:
a distribution of nanoparticles, the nanoparticles comprising Ni, Cu, Sn, Ag, Ti, V, Cr, Zn, Ru, Rh, Pt, Au, Fe, C, oxides thereof, composites thereof, complexes thereof, alloys thereof, or mixtures thereof, wherein
the distribution of nanoparticles ranges from about 1 wt % to about 95 wt % of the nanofluid; and
a viscosity of the nanofluid is in a range of from about 1 cP to about 5000 cP.

2. The catalytic nanofluid of claim 1, further comprising an organic graft on at least a portion of the distribution of nanoparticles.

3. The catalytic nanofluid of claim 2, wherein the organic graft comprises a silane-based organic material, an amine, or a mixture thereof.

4. The catalytic nanofluid of claim 3, wherein the silane-based organic material comprises 3-(trihydroxysilyl)-1-propane sulfonic acid.

5. The catalytic nanofluid of claim 1, wherein on an individual basis the organic graft comprises from about 2 wt % to about 20 wt % of a nanoparticle.

6. The catalytic nanofluid of claim 2, wherein on an individual basis the organic graft comprises from about 3 wt % to about 7 wt % of a nanoparticle.

7. The catalytic nanofluid of claim 1, wherein the distribution of nanoparticles ranges from about 20 wt % to about 40 wt % of the nanofluid.

8. The catalytic nanofluid of claim 1, wherein the viscosity of the nanofluid is in a range of from about 2 cP to about 10 cP.

9. The catalytic nanofluid of claim 1, wherein the nanofluid is substantially free of agglomerations.

10. The catalytic nanofluid of claim 1, wherein a largest dimension of an individual nanoparticle is in a range of from about 85 nm to about 500 nm.

11. The catalytic nanofluid of claim 1, wherein a largest dimension of an individual nanoparticle is in a range of from about 100 nm to about 150 nm.

12. A device comprising:
a carbon dioxide inlet;
the catalytic nanofluid of claim 1, in communication with the carbon dioxide inlet;
an electrode; and
a reaction product outlet.

13. The device of claim 12, wherein the device is capable of producing about 3 kg/day to about 2000 kg/day of reaction product.

14. The device of claim 12, wherein the device is capable of producing about 1000 kg/day to about 2000 kg/day of reaction product.

15. The device of claim 12, further comprising a pump to move the nanofluid.

16. The device of claim 12, wherein the reaction product comprises formate, methane, or a mixture thereof.

17. The device of claims 12, wherein the electrode is located at a downstream location that the nanofluid can be selectively contacted with.

18. A method of capturing carbon dioxide, the method comprising:
contacting carbon dioxide with the nanofluid of any of claim 1.

19. A method of converting carbon dioxide into a reaction product, the method comprising:
contacting the nanofluid of claim 18 with an electrode; and
applying an electrical current to the electrode.

20. The method of claim 19, wherein about 80 wt % to about 95 wt % of the total amount of carbon dioxide contacted with the nanofluid is converted to the reaction product.
